(19) United States
(12) Patent Application Publication
(10) Pub. No.: US 2025/0251036 A1
(43) Pub. Date: Aug. 7, 2025

(54) LOW PROFILE WAVE STRAIN GEARBOX

(71) Applicant: M.Y.P. Advanced Technologies (1995) Ltd., Holon (IL)

(72) Inventor: Alexander GORINSTEIN, Netanya (IL)

(21) Appl. No.: 19/191,251

(22) Filed: Apr. 28, 2025

Related U.S. Application Data
(63) Continuation of application No. 17/829,417, filed on Jun. 1, 2022, now abandoned.
(60) Provisional application No. 63/195,212, filed on Jun. 1, 2021.

(51) Int. Cl. F16H 49/00

(52) U.S. Cl. CPC F16H 49/001; F16H 2049/003

(57) ABSTRACT

A wave transmission gearbox includes an output wheel, a deformable gear band, a low profile fixed spline, a wave generator, and a flexible-band-compensating rigid torque transmitter. The deformable gear band has external teeth transmitting relative torque motion to the output wheel, and is as wide as its external teeth. The low profile fixed spline has internal teeth meshing with the external teeth of the deformable gear band, and has a width which is a function of the width of the deformable gear band. The wave generator deforms the deformable gear band within the low profile fixed spline to generate relative torque motion between the deformable gear band and the low profile fixed spline. The flexible-band-compensating rigid torque transmitter transfers relative torque motion from the deformable gear band to the output wheel.

### CROSS REFERENCE TO RELATED APPLICATIONS

This application is a continuation application of U.S. patent application Ser. No. 17/829,417, filed Jun. 1, 2022, which claims priority from U.S. Provisional Patent Application 63/195,212, filed Jun. 1, 2021, both of which are incorporated herein by reference.

### FIELD OF THE INVENTION

The present invention relates to mechanical gearing systems generally and to strain wave gearing in particular.

### BACKGROUND OF THE INVENTION

Wave strain drives use an externally geared flexible spline and an internally geared fixed circular spline. The externally geared flex spline has less teeth than the fixed circular spline, and is deformed by a wave generator or elliptical drive attached to a motor. The externally geared flex spline is fixed to an output shaft and drives a load.

Reference is made to FIG. 1 which is a schematic exploded illustration of a wave strain drive 10. Wave strain drive 10 has a wave generator or elliptical drive 11 attached to a motor 15. A round the outside of wave generator 11 is a flexible bearing 16. Wave generator 11 fits inside flexible spline 12, and flexible bearing 16 conforms to the shape of wave generator 11.

Wave strain drive 10 has a flexible spline 12 (also called a ‘flexi spline’ or ‘flexispline’) in the form of a cylinder with an open end 14 and a closed end 17. A band of externally geared teeth 18 surrounds open end 14. Closed end 17 is used to a drive a load. Open end 14 is somewhat flexible, and closed end 17 is not. Flexible spline 12 is inserted into a fixed circular spline 13, which has a band of internally geared teeth 19. Gear teeth 18 and 19 are of similar sizes and mesh. The circumference of flexible spline 12 is smaller than the circumference of fixed circular spline 13, usually by the size of two gear teeth 18 or 19.

Reference is made to FIG. 2 which is an end view schematic illustration of wave strain drive 10 at rest. Elliptically shaped wave generator 11 can be seen in the center of drive 10 and has been shaded with hatching for clarity. Flexible bearing 16 conforms to the elliptical shape of wave generator 11. Wave generator 11 together with flexible bearing 16 is inserted into flexible spline 12, and wave generator 11 causes flexible spline 12 to deform to conform to the elliptical shape of wave generator 11. The wave generator 11 and flexible spline assembly 12 are inserted into fixed circular spline 13. As flexible spline 12 has a smaller circumference than fixed spline 13, and has been deformed by wave generator 11, such a deformation causes external teeth 18 of flexible spline 12 to engage with the internal teeth 19 of fixed circular spline 13 at the widest points of the elliptical shape of wave generator 11. At the same time, small gaps 22 open between flexible spline 12 and fixed spline 13 at the narrowest points of the elliptical shape of wave generator 11. As the drawing represents drive 10 at rest, reference point A on fixed spline 13 is shown aligned with reference point B on flexible spline 12.

As wave generator 11 rotates, flexible bearing 16 deforms, and deforms flexible spline 12. This ‘rolling’ engagement of flexible spline 12 with fixed spline 13 causes flexible spline 12 to rotate 2 teeth with respect to fixed spline 13, for every full revolution of wave generator 11.

Reference is made to FIG. 3 which is a schematic illustration of wave strain drive 10 in motion. As mentioned hereinabove, flexible spline 12 has 2 teeth less than fixed circular spline 13. When wave generator 11 rotates clockwise (as indicated by arrow 31), it causes flexible spline 12 to ‘roll’ against fixed spline 13, in a counterclockwise direction (as indicated by arrow 32). The ‘rolling’ motion is caused by the wider ends of wave generator 11 engaging the external teeth 18 of flexible spline 12 into the internal teeth 19 of fixed spline 13, which causes flexible spline 12 to roll 2 teeth with respect to fixed spline 13, for every rotation of wave generator 11. At the narrower ends of the elliptical shape of wave generator 11, gap 22 opens between fixed spline 13 and flexible spline 12. FIG. 3 shows wave generator 11 after it has completed about 9 clockwise rotations. Flexible spline 12 has rotated about 90 degrees, or 18 teeth, with respect to fixed spline 13. As a result, the position of reference point B on flexible spline 12 has moved about 18 teeth counterclockwise relative to reference point A on fixed spline 13.

Reference is briefly made to FIGS. 4A and 4B which are schematic illustrations of open end 14 of flexible spline 12. As shown in FIG. 4A, when the widest sides of wave generator 11 are in the sidemost positions (as shown in FIG. 3), then flexible spline 12 is deformed such that reference points Q and S on band of gear teeth 18 are pushed outwards (indicated by arrows 41) from a center 43, while reference points P and R on band of gear teeth 18 are pushed inwards (indicated by arrows 42) towards center 43 of flexible spline 12. As shown in FIG. 3, this deformation causes reference points Q and S to engage with teeth 19 of fixed spline 13. Likewise, as shown in FIG. 4B, when the widest sides of wave generator 11 are in the upper most and lower most positions (as shown in FIG. 2), then flexible spline 12 is deformed such that reference points Q and S on band of gear teeth 18 are pushed inwards (indicated by arrows 46) towards center 43, while reference points P and R on band of gear teeth 18 are pushed outwards (indicated by arrows 45) from center 43 of flexible spline 12. It should be noted that the relative movement between points around open end 14 of flexible spline 12 and corresponding points around the edge of closed end 17 of flexible spline 12 is accommodated by the flexible nature of flexible spline 12. Backlash between open end 14 of flexible spline 12 and closed end 17 of flexible spline 12 is also minimized by the flexible nature of flexible spline 12.

The transmission ratio, i, of wave strain drive 10 is a function of the number of teeth, z_{flexible} on flexible spline 12, and the number of teeth, zⱼ, on fixed circular spline 13. The transmission ratio i can be calculated according to equation 1.

$$i = \frac{{z}_{flexible}}{{z}_{j} - {z}_{flexible}} \qquad ( 1 )$$

It should be noted that the absolute tooth count is a function of the size of each gear tooth, and the circumference of flexible spline 12 and fixed circular spline 13.

Reference is made to FIG. 5 which is a schematic illustration of an assembled wave strain drive 10. Flexible spline 12 rotates inside fixed spline 13, with external teeth 18 of flexible spline 12 and internal teeth 19 of fixed spline 13 meshing as a function of the rotation of wave generator 11. Wave generator 11, surrounded by flexible bearing 16, is driven by an input shaft 51, and the reduced geared output of flexible spline 12 is used to drive an output shaft 52.

### SUMMARY OF THE PRESENT INVENTION

There is therefore provided, in accordance with a preferred embodiment of the present invention, a wave transmission gearbox. The gearbox includes an output wheel, a deformable gear band, a low profile fixed spline, a wave generator, and a flexible-band-compensating rigid torque transmitter. The deformable gear band has external teeth transmitting relative torque motion to the output wheel, and is as wide as its external teeth. The low profile fixed spline has internal teeth meshing with the external teeth of the deformable gear band, and has a width which is a function of the width of the deformable gear band. The wave generator deforms the deformable gear band within the low profile fixed spline to generate relative torque motion between the deformable gear band and the low profile fixed spline. The flexible-band-compensating rigid torque transmitter transfers relative torque motion from the deformable gear band to the output wheel.

Moreover, in accordance with a preferred embodiment of the present invention, the flexible-band-compensating rigid torque transmitter includes, a plurality of spline flanges attached to the deformable gear band, and a plurality of force transmitting joints. The plurality of force transmitting joints attach to the output wheel and to the plurality of spline flanges and accommodate a deformation of the deformable gear band.

Further, in accordance with a preferred embodiment of the present invention, the force transmitting joints are a conjugating force transmitting joint or a planar force transmitting joint.

Still further, in accordance with a preferred embodiment of the present invention, the conjugating force transmitting joint includes an output flange and a force transmitting pin conjugating within the output flange, the output flange having a 4-point conjugating slot profile or a 2-point conjugating slot profile.

Additionally, in accordance with a preferred embodiment of the present invention, the planar force transmitting joint includes a planar interface, and a force transmitting pin engaging the planar interface.

Moreover, in accordance with a preferred embodiment of the present invention, the planar interface has a cylindrical torsional spring profile.

Further, in accordance with a preferred embodiment of the present invention, the planar interface has a conical torsional spring profile and a portion of the force transmitting pin is conical.

Still further, in accordance with a preferred embodiment of the present invention, the planar interface is integrally formed with the force transmitting pin.

Additionally, in accordance with a preferred embodiment of the present invention, the plurality of force transmitting joints are attached to the output wheel with a fixed pitch, a variable pitch, or a free-rotating pitch.

Moreover, in accordance with a preferred embodiment of the present invention, the plurality of spline flanges is attached to one tooth of the deformable gear band, an inner face of the deformable gear band, an inner lateral face of the deformable gear band, or an outer lateral face of the deformable gear band.

There is therefore provided, in accordance with a preferred embodiment of the present invention, a wave transmission slewing drive. The drive includes an output wheel, a deformable gear band, a low profile fixed spline, a wave generator, a flexible-band-compensating rigid torque transmitter, and a toroidal motor. The deformable gear band has external teeth transmitting relative torque motion to the output wheel, and is as wide as its external teeth. The low profile fixed spline has internal teeth meshing with the external teeth of the deformable gear band, and has a width which is a function of the width of the deformable gear band. The wave generator deforms the deformable gear band within the low profile fixed spline to generate relative torque motion between the deformable gear band and the low profile fixed spline. The flexible-band-compensating rigid torque transmitter transfers relative torque motion from the deformable gear band to the output wheel. The toroidal motor provides motive force to the wave generator.

Moreover, in accordance with a preferred embodiment of the present invention, the toroidal motor is a brushless toroidal motor.

Further, in accordance with a preferred embodiment of the present invention, the output wheel has a central cavity, the deformable gear band has a central cavity, the low profile fixed spline has a central cavity, the wave generator has a central cavity, and the toroidal motor has a central cavity, and the central cavities together form a through-hole to provide passage for electric cables, pneumatic cables, or fiber optic cables.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exploded schematic illustration of a prior art wave strain drive;

FIG. 2 is a schematic illustration of the wave strain drive of FIG. 1 at rest;

FIG. 3 is a schematic illustration of the wave strain drive of FIG. 1 in motion;

FIGS. 4A and 4B are schematic illustrations of the open end of the flexible spline of the wave strain drive in FIG. 1;

FIG. 5 is a composite schematic illustration of the wave strain drive of FIG. 1;

FIG. 6 is a side view schematic illustration of the flexible spline of the wave strain drive of FIG. 1;

FIG. 7A is a schematic illustration of an exemplary low profile wave strain gearbox, constructed and operative in accordance with a preferred embodiment of the present invention;

FIG. 7B is a schematic illustration of the torque transmission system of the low profile wave strain gearbox of FIG. 7A;

FIGS. 8A, 8B and 8C are schematic illustrations of the deformable gear band of the low profile wave strain gearbox of FIG. 7A;

FIGS. 9A, 9B and 9C are schematic illustrations of output flange configurations on the output wheel of the low profile wave strain gearbox of FIG. 7A;

FIGS. 10A and 10B are schematic illustrations of output flanges of the low profile wave strain gearbox of FIG. 7A;

FIGS. 11A, 11B, 11C and 11D are schematic illustrations of planar interfaces of the low profile wave strain gearbox of FIG. 7A;

FIG. 12 is an exploded view schematic illustration of an exemplary low profile wave transmission ring gearbox; and

FIGS. 13A, 13B, 13C and 13D are schematic illustrations of an exemplary low profile wave transmission rotary slewing drive.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

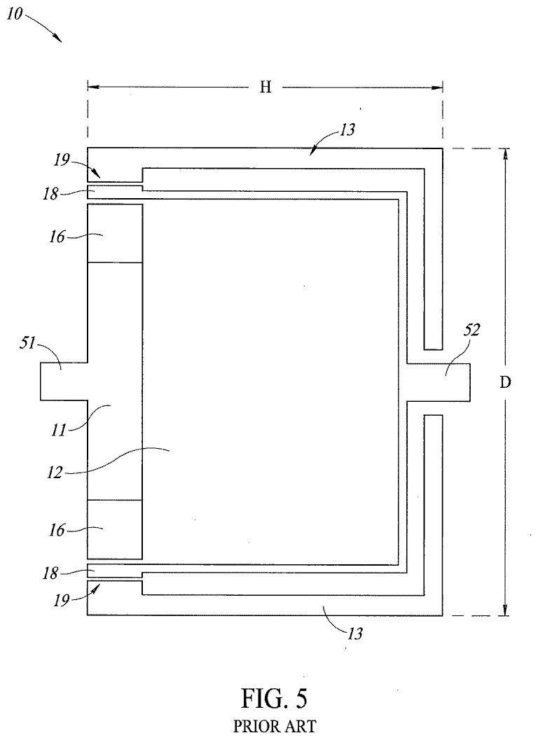

Applicant has realized that prior art strain wave drive assemblies approximate to a cube shape. FIG. 5 shows the diameter, D, and the height, H, of wave strain drive 10. As can be seen, diameter D and height H of the drive 10, are comparable to one another.

Applicant has realized that, because diameter D and height H of the drive 10 are comparable, prior art wave strain type drives may not be appropriate in applications requiring low profile gearboxes, for example in slewing drives for robotics.

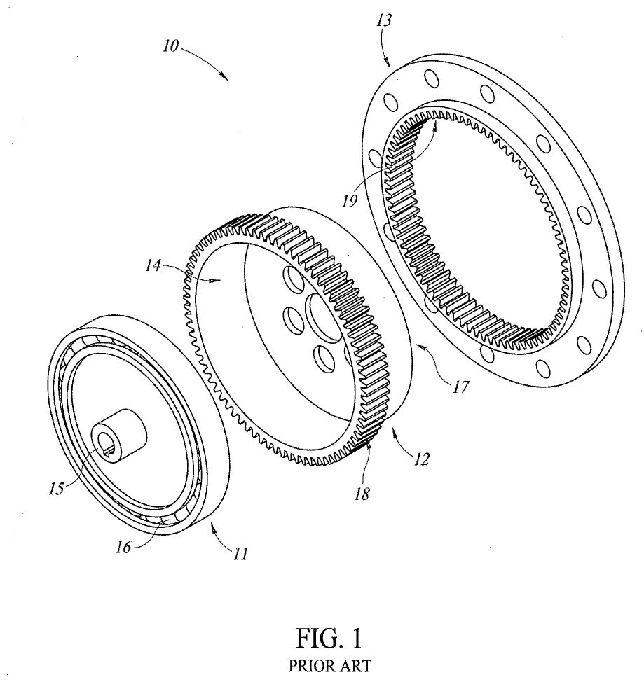

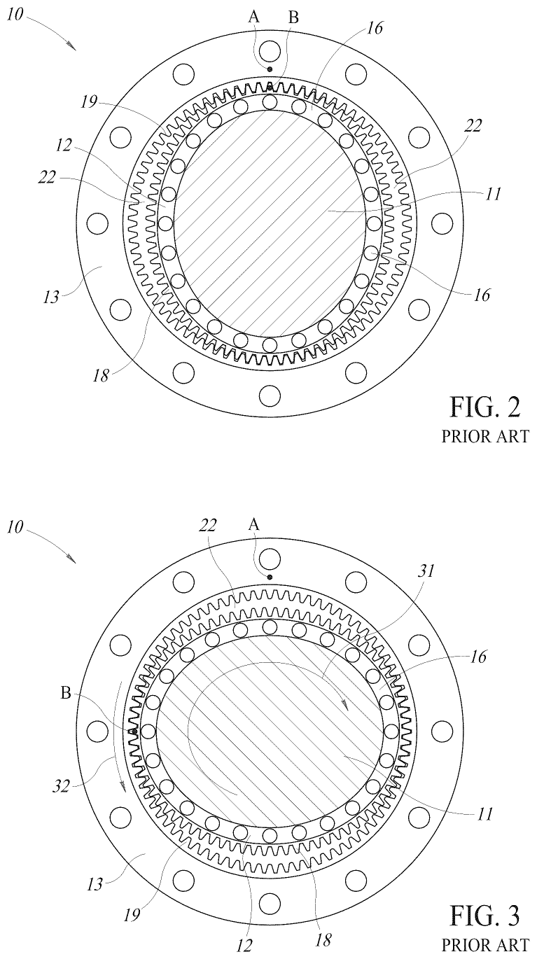

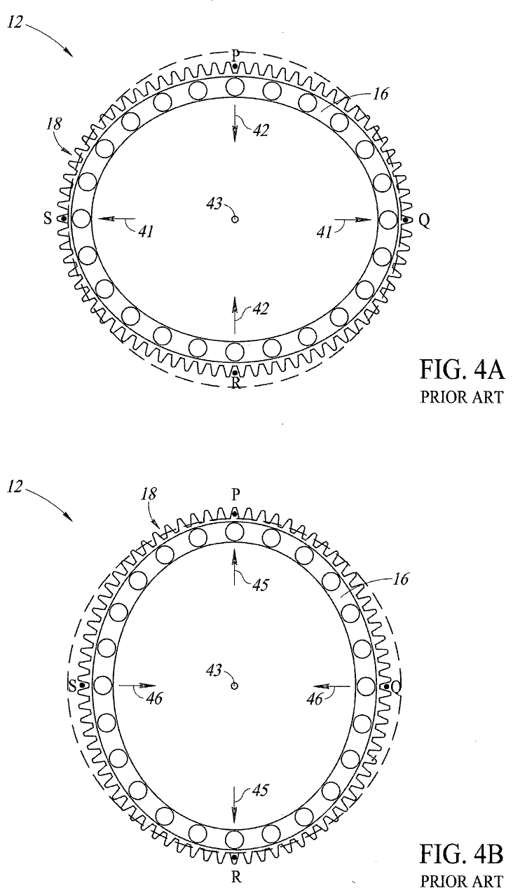

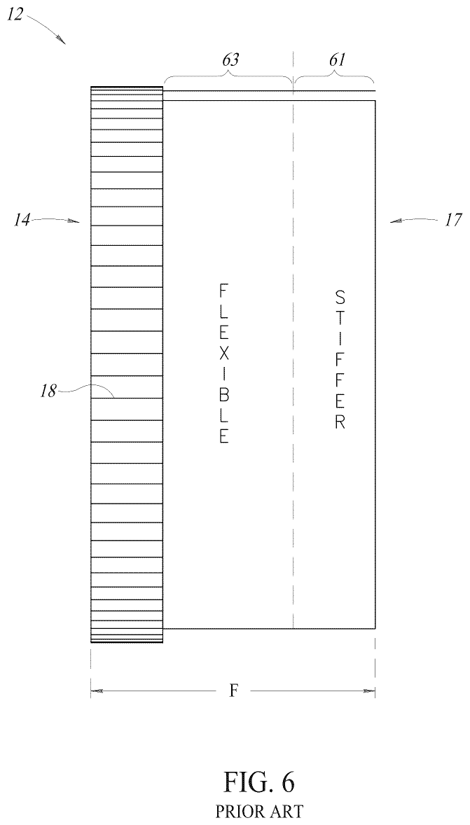

Reference is made to FIG. 6, which is a schematic illustration of the side view of flexible spline 12 of FIGS. 1 and 5. Applicant has also realized that height H of a wave strain drive is primarily due to the height, F, of the flexible spline (the distance between its closed end 17 and open end 14) as shown in FIG. 6. This size is a result of the design requirements for flexible spline 12.

Flexible spline 12 has a stiffer region 61 towards its closed end 17, and a flexible region 63 towards its open end 14. As mentioned hereinabove, closed end 17 drives an output load, so it is stiffer in nature, whereas open end 14 is deformable so it is flexible in nature. To provide the level of flexibility required to deform open end 14 of flexible spline 12, without deforming stiffer region 61, while at the same time remaining strong enough to transfer motive torque from external gear teeth 18 to closed end 17, prior art designs stipulate that flexible region 63 must have a length F, which is comparable to depth D of drive 10.

### Lowering the Profile of a Wave Strain Drive

As discussed hereinabove, due to the design constraint that flexible spline 12 be flexible enough to deform, while strong enough to transmit torque, wave strain drives and gearboxes are inherently ‘high profile’ devices. Applicant has realized that, by separating the ‘flexible’ and ‘strong’ characteristics of flexible spline 12 from a single element to a number of different elements, an output wheel (commensurate with the closed end 17 of flexible spline 12) may be positioned closer to a flexible band of geared teeth (commensurate with externally geared teeth 18 around open end 14 of flexible spline 12), thus length F of flexible spline 12 may be reduced and thus, a low profile wave strain drive may be produced, as explained in detail hereinbelow.

### Low Profile Wave Strain Gearbox Overview

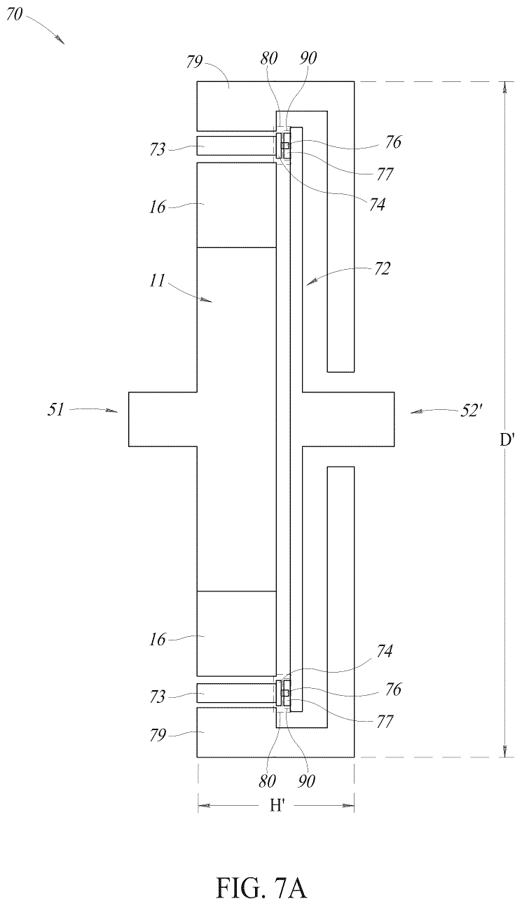

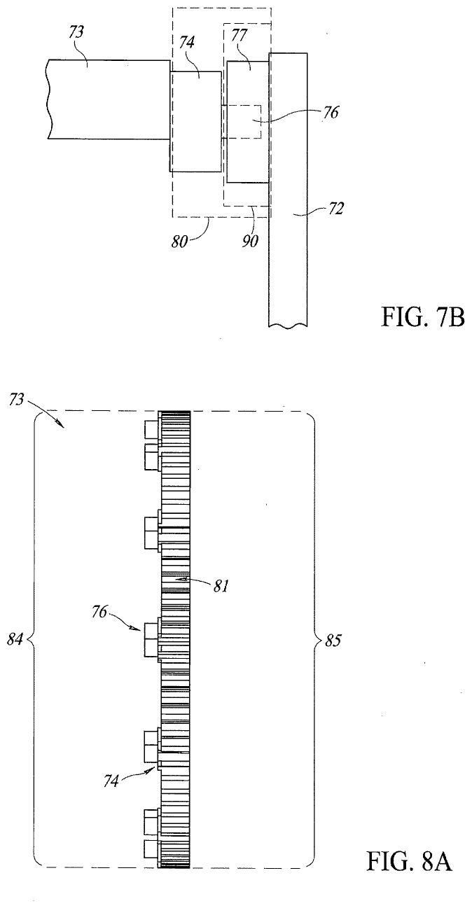

Reference is made to FIG. 7A which is a schematic illustration of a low profile wave transmission gearbox 70, which comprises wave generator 11, flexible bearing 16, a low profile fixed circular spline 79, a deformable gear band 73, an output wheel 72, a flexible-band-compensating rigid torque transmitter (FRTT) 80, an input shaft 51 and an output shaft 52′. FRTT 80 comprises spline flanges 74, and a force transmitting joint 90. Force transmitting joint 90 comprises force transmitting pins 76, and output flanges 77.

Low profile wave transmission gearbox 70 operates similarly to traditional wave strain drive 10 in that the combination of wave generator 11, flexible bearing 16, low profile fixed circular spline 79, and deformable gear band 73 creates a relative output torque motion between low profile fixed circular spline 79 and deformable gear band 73. The height, H′, of low profile wave transmission gearbox 70 is significantly smaller than height H of a traditional wave strain drive 10. It should be noted that height H′ of low profile wave transmission gearbox 70 may be more than 50% smaller than traditional wave strain drive 10 where diameter D′ is comparable to diameter D. It should also be noted that low profile wave transmission gearbox 70 may be implemented in larger diameters, for example D′=300 mm, which are impractical to implement in traditional wave strain drives 10. In such large diameter devices, if such diameters could be implemented in traditional wave strain drives 10, the reduction in diameter D′ may be as high as 90%.

In low profile wave transmission gearbox 70, the relative output torque motion between low profile fixed circular spline 79 and deformable gear band 73 is transmitted to output wheel 72 via FRTT 80. Reference is made to FIG. 7B which is a detailed schematic illustration of FRTT 80 of low profile wave transmission gearbox 70. Output torque motion from deformable gear band 73 is transmitted to output wheel 72 through force transmitting joints 90 which are mounted to deformable gear band 73 and to output wheel 72. Force transmitting pins 76 of force transmitting joints 90, attach to deformable gear band 73 via spline flanges 74 attached to deformable gear band 73. Force transmitting pins 76 then conjugate with output flanges 77 of force transmitting joints 90.

It will be appreciated that the use of an FRTT 80 may allow low profile wave transmission gearbox 70 to be ‘packaged’ in a smaller form factor than traditional wave strain drive 10.

### Transmission Ratio

The transmission ratio, iₗₚ, for low profile wave strain drive 70 can be calculated similarly to a standard wave strain drive as described hereinabove, according to equation 2.

$${i}_{l p} = \frac{{z}_{flexiblelp}}{{z}_{jlp} - {z}_{flexiblelp}} \qquad ( 2 )$$

where z_{flexiblelp} is the number of teeth on deformable gear band 73, zⱼₗₚ is the number of teeth on low profile fixed circular spline 79.

### Deformable Gear Band

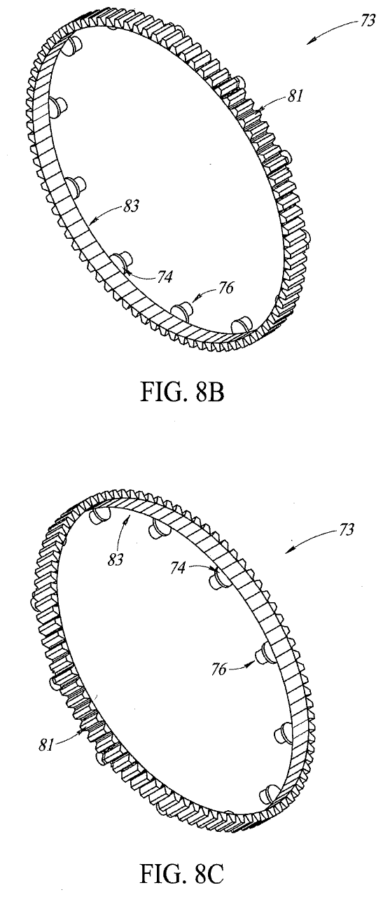

Reference is made to FIGS. 8A, 8B and 8C which are schematic illustrations of deformable gear band 73. Deformable gear band 73 comprises external teeth 81, an inner face 83, an outer lateral face 84, and an inner lateral face 85. Spline flanges 74 may be attached to one or more teeth 81 on outer lateral face 84 of deformable gear band 73. Force transmitting pins 76 may be attached to spline flanges 74 and may extend away from inner lateral face 85 of deformable gear band 73 towards output wheel 72 (shown in FIG. 7A) and conjugate with output flanges 77 (shown in FIG. 7A) mounted on output wheel 72. Deformable gear band 73 may be implemented from any suitable material such as, but not limited to, plastics, composites and metal. It should be noted that spline flanges 74 may be attached to any part of deformable gear band 73, and not only to the outer lateral face 84 as shown. For example, they may be attached to inner face 83.

Spline flanges 74 may be attached to deformable gear band 73 by any suitable method, for example but not limited to, welding, glue or push fit. It will be appreciated that deformable gear band 73 and spline flanges 74 may be produced as a single composite element, for example by 3D printing technology. Likewise, deformable gear band 73, spline flanges 74 and force transmitting pins 76 may also be produced as a single composite element.

It should also be noted that an increased area of spline flanges 74 may allow for larger diameter force transmitting pins 76 to be attached to deformable gear band 73, compared with the diameter of force transmitting pins 76 that may be attached directly to teeth 81 of deformable gear band 73. Larger diameter force transmitting pins 76 may allow deformable gear band 73 to transmit high torque to output wheel 72.

### Force Transmitting Joint Configuration

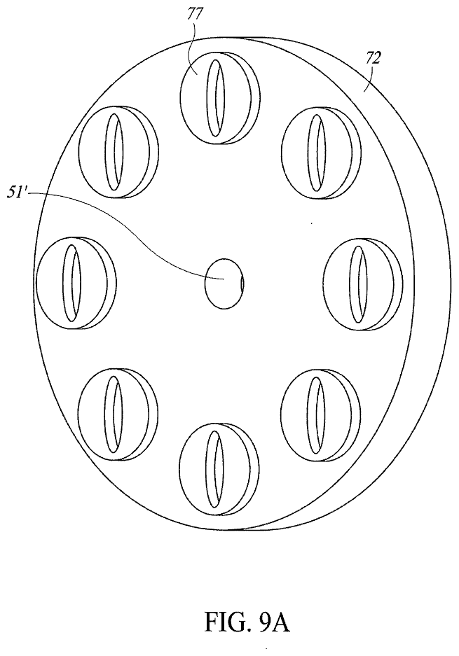

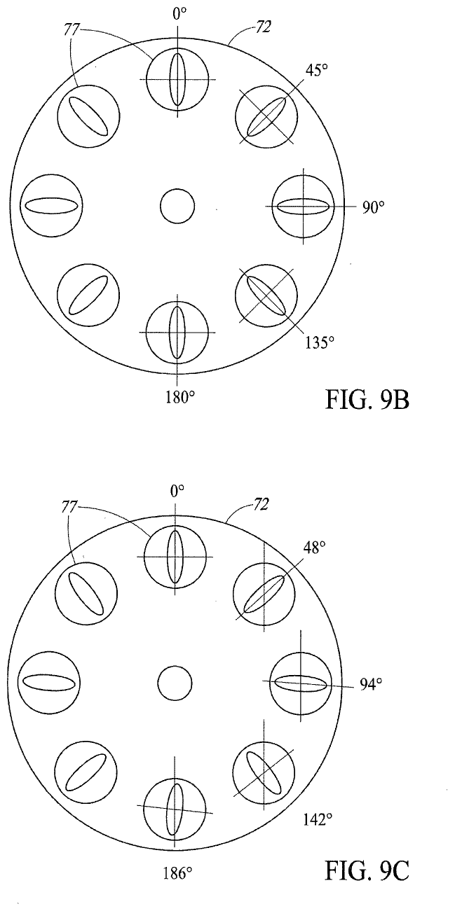

Reference is briefly made to FIG. 9A which is a schematic illustration of the arrangement of output flanges 77, of force transmitting joints 90, on output wheel 72. A number of output flanges 77 may be attached onto output wheel 72 to distribute turning forces between output wheel 72 and deformable gear band 73. It should also be noted that by increasing the number of output flanges 77 together with a commensurate number of spline flanges 74 and force transmitting pins 76, a higher total torque may be transmitted from deformable gear band 73 to output wheel 72.

It should be noted that output flanges 77 may either be attached to output wheel 72 such that they are in a fixed position and fixed rotation, or they may be fixed in position but have rotational free movement. The following assumes an embodiment with output flanges 77 in a fixed position and fixed rotation.

Reference is made to FIGS. 9B and 9C which are schematic illustrations of an exemplary configuration of output flanges 77 on output wheel 72. In the example, eight output flanges 77 may be attached around output wheel 72 with an equal 45 degree offset to one another as shown in FIG. 9B or with unequal degrees of offset as shown in FIG. 9C, that may be used to accommodate deformations in deformable gear band 73. It will be appreciated that the actual pitch of such rotations of output flanges 77 may be set to any value relative to one another, and that the examples herein merely illustrate rather than limit designs.

### Force Transmitting Joint Design

As mentioned hereinabove, there is a relative movement between points around the edge of flexible spline 12 and output wheel 72, which manifests as relative movement between force transmitting pins 76 and output flanges 77. Applicant has realized that the change in position of force transmitting pins 76 in relation to output wheel 72 caused by the deforming of deformable gear band 73, may be accommodated by force transmitting joint 90. Output flanges 77 of force transmitting joint 90, are designed to accommodate such relative movement, The design of force transmitting joint 90 also minimizes backlash in transmission between deformable gear band 73 and output wheel 72.

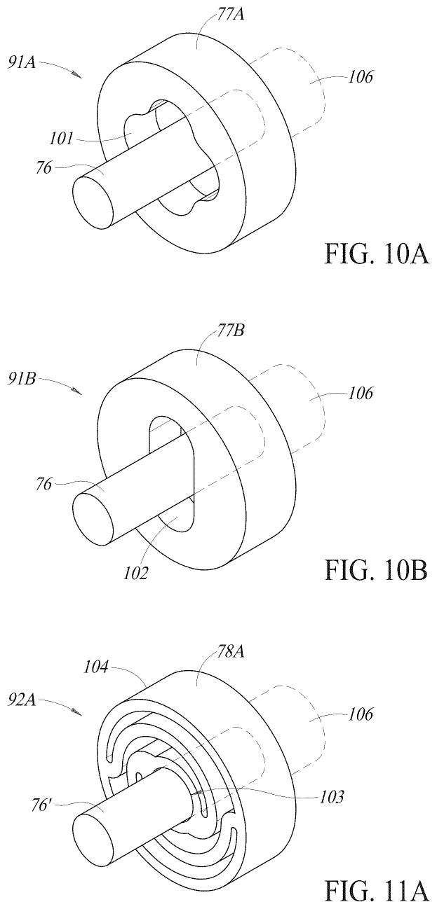

Reference is made to FIGS. 10A and 10B, which are schematic illustrations of exemplary conjugating force transmitting joints 91A and 91B respectively. FIG. 10A shows conjugating force transmitting joint 91A which has a 4-point conjugating slot profile 101 in its output flange 77A, which allows for the movement of force transmitting pin 76 within slot 101. 4-point conjugating slot profile 101 may be an analog of the movement of force transmitting pins 76 under deflection during one wave generator 11 rotation. FIG. 10B shows conjugating force transmitting joint 91B which has a 2-point conjugating slot profile 102 in its output flange 77B. It should be noted, as mentioned hereinabove, that in a preferred embodiment, output flanges 77A and 77B may not have a fixed pitch, and may be attached to output wheel 76 by an optional pin 106 that may allow output flanges 77A and 77B to rotate in response to movement of force transmitting pin 76 within their slot profiles 101 and 102. It should be noted that pin 106 may be fixed to output wheel 76 such that flanges 77A and 77B do not move. Flanges 77A and 77B may also be attached directly to output wheel 76 without pin 106.

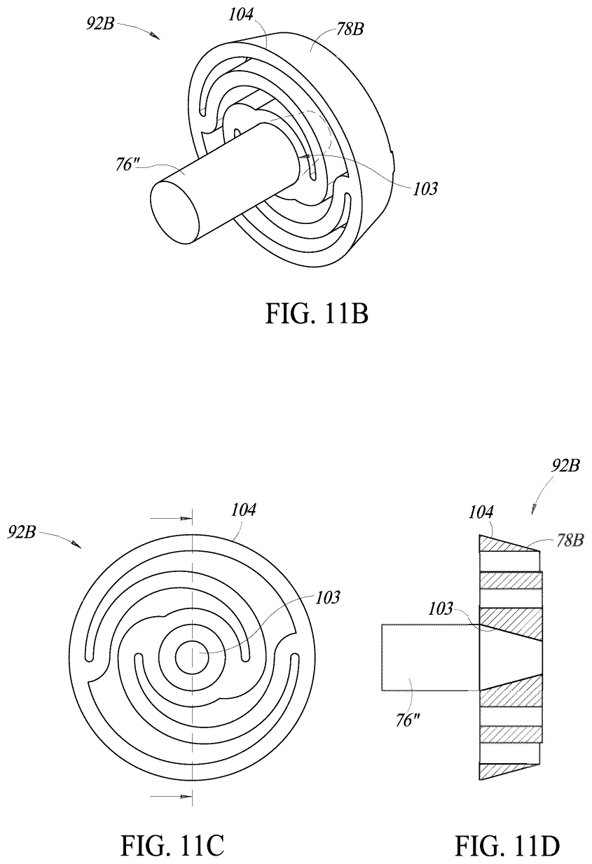

In another embodiment, force transmitting joints 90 may be planar force transmitting joints. Reference is made to FIGS. 11A, 11B, 11C and 11D which are schematic illustrations of exemplary planar force transmitting joints 92A 92A and 92B 92B.

FIG. 11A shows planar force transmitting joint 92A. In this embodiment, force transmitting pin 76′ is either integrally connected or inserted (for example via frictional push-fit) into planar interface 78A. Planar interface 78A has a torsional spring profile with an inner channel 103 and an outer edge 104. Force transmitting pin 76′ is ‘suspended’ inside the torsional spring profile of planar interface 78A that may allow planar free-movement in response to planar movement of force transmitting pins 76′. Planar interface 78A is shown with optional pin 106 to mount it to output wheel 76, which may be fixed in place or allow planar interface 78A to rotate.

FIGS. 11B, 11C and 11D show another planar force transmitting joint 92B, similar to force transmitting joint 92A, but with planar interface 78B which has a conical rather than cylindrical profile. Such a profile may achieve a tighter fit of force transmitting pin 76″ (which may have at least a section that is conical) into channel 103. A gain, force transmitting pin 76″ may be inserted into planar interface 78B or fixedly attached by appropriate means. Planar interface 78B is shown without optional pin 106, but pin 106 may be used to mount it to output wheel 76, which may be fixed in place or allow planar interface 78A to rotate.

It will be appreciated that the above conjugating flange and planar interface designs are brought as examples and are not intended to limit design possibilities.

### Low Profile Wave Transmission Gearbox

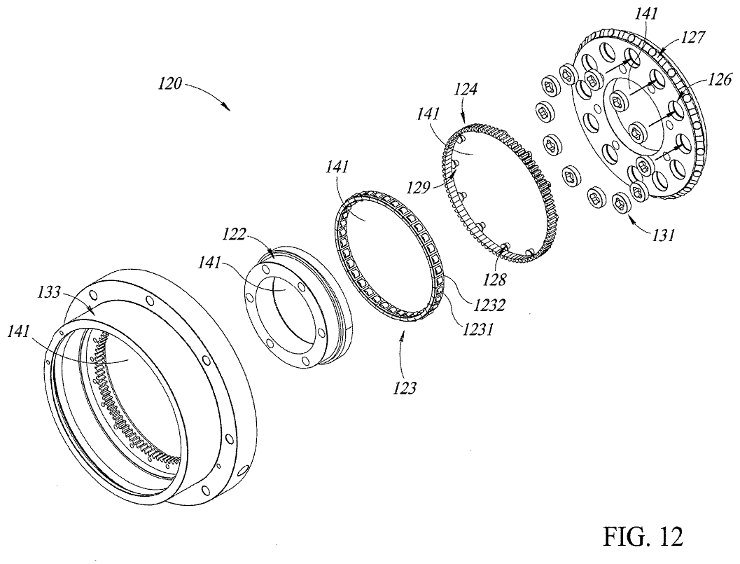

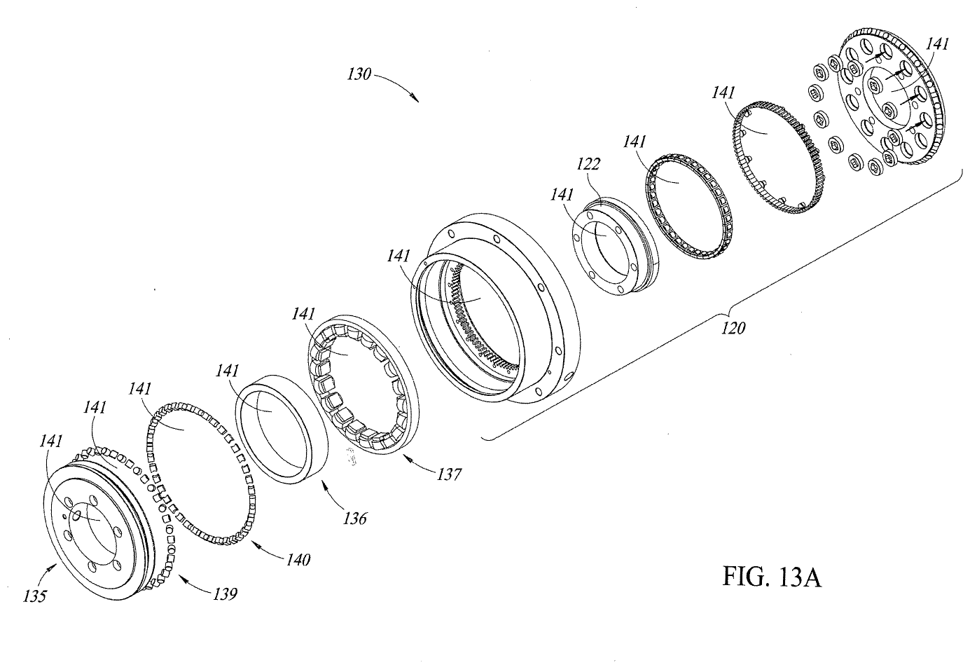

Reference is now made to FIG. 12 which is an exploded view schematic illustration of an exemplary low profile wave transmission ring gearbox 120. Gearbox 120 comprises a wave generator 122, deformable bearings 123, deformable gear band 124, output wheel 126, output bearing 127, and fixed circular spline 133. Deformable bearings 123 comprises rolling elements 1231 (cylindrical rollers, barrel shaped rollers or balls) separated by elastic separator 1232. Deformable gear band 124 comprises spline flanges 128, and force transmitting pins 129. Output wheel 126 comprises output flanges 131.

It should be noted that exemplary low profile wave transmission ring gearbox 120 may have a through-hole 141 (which is a cavity) through the center of the device as indicated in FIG. 12. Such a through-hole 141 may be used to thread cables, pneumatic tubes or fiber optic cables through the slewing gearbox 120 to supply, for example, power or lubrication.

### Low Profile Wave Transmission Rotary Slewing Drive

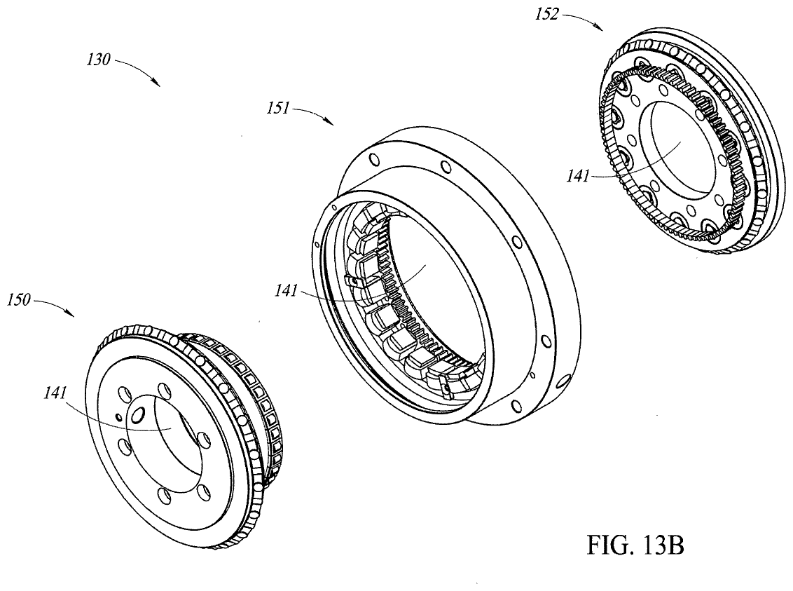

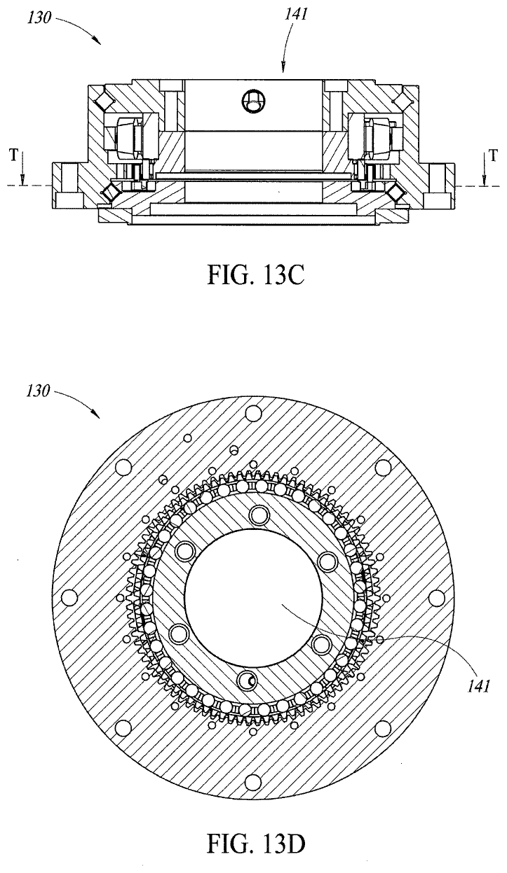

Reference is now made to FIG. 13A which is an exploded view schematic illustration of an exemplary low profile wave transmission rotary slewing drive 130. Slewing drive 130 comprises the low profile wave transmission ring gearbox 120 of FIG. 12, and further comprises an input wheel 135, a rotor of toroidal brushless motor 136, a stator of toroidal brushless motor 137, input bearings 139 and input bearing separators 140.

Rotor of brushless motor 136 may be mounted on input wheel 135 and secured by any appropriate means to wave generator 122 to form a single ring. For example, but not limited to, welding, glue or other appropriate binding technology may be used.

It should be noted that exemplary low profile wave transmission rotary slewing drive 130, similar to exemplary low profile wave transmission ring gearbox 120, may have a through-hole 141 through the center of the device as indicated in FIGS. 13A, 13B, 13C and 13D.

Reference is briefly made to FIG. 13B which is a partially exploded view schematic illustration of exemplary low profile wave transmission rotary slewing drive 130. The drawing shows drive components combined into an input assembly 150, a static assembly 151 and an output assembly 152.

Input assembly 150 comprises input wheel 135, rotor of brushless motor 136, input bearings 139, input bearing separators 140, wave generator 122, deformable bearings 123, deformable gear band 124, spline flanges 128, and force transmitting pins 129.

Static assembly 151 comprises fixed circular spline 133, stator of brushless motor 137,

Output assembly 152 comprises output wheel 126, output bearing 127, output flanges 131.

Reference is briefly made to FIG. 13C which is a section view schematic illustration of exemplary low profile wave transmission rotary slewing drive 130.

Reference is briefly made to FIG. 13D which is a plan view schematic illustration of exemplary low profile wave transmission rotary slewing drive 130.

### Advantages of Low Profile Wave Transmission Rotary Slewing Drive

It will be appreciated that motor and gearbox are incorporated into low profile wave transmission rotary slewing drive 130 as a single unit. Such a slewing drive may be low profile for use in robotic arms systems, thereby reducing design complexity for the user. Such a slewing drive may also be incorporated into applications requiring azimuth and elevation motion, with significant ease of design.

Therefore, a designer might use low profile wave transmission rotary slewing drive 130 as a universal solution for various mechanisms or systems requiring azimuth and/or elevation motion and capable of carrying significant tilting moments.

It will be appreciated that the use of spline flanges 128 instead of direct attachment of force transmitting pins 129 to deformable gear band 124 provides for an increased pin diameter over and above the band thickness alone, and therefore provides for increased transmitted torque via a large diameter pin shaft.

It will be appreciated that the use of output flanges 77A and 77B (as shown in FIGS. 10A and 10B respectively), and planar interfaces 78A and 78A 78B (as shown in FIGS. 11A, 11B, 11C and 11D) have different output flange designs, and may provide for different options for force or torque transmission profiles, such as by a conjugating force transmitting joint 91A or a planar force transmitting joint 91B.

Connection between output flanges 77A and 77B, and planar interfaces 78A and 78B, to output wheel 126 may be by press fit, slip fit, or attached by any method of fixing, depending on design considerations. Output flanges may have rotational freedom or may be fixed pitch.

It will be appreciated that low profile wave transmission rotary slewing drive 130 may have a through-hole 141 which may be used to thread cables or pneumatic tubes through the slewing gearbox 120 to supply, for example, power or lubrication. Such a through-hole 141 may be, for example, 50% of the diameter of low profile wave transmission rotary slewing drive 130.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A wave transmission gearbox, the gearbox comprising:
an output wheel;
a deformable gear band having external teeth, to transmit relative torque motion to said output wheel, said deformable gear band being as wide its external teeth;
a low profile fixed spline having internal teeth, to mesh with said external teeth of said deformable gear band, having a width which is a function of said width of said deformable gear band;
a wave generator to deform said deformable gear band within said low profile fixed spline to generate said relative torque motion between said deformable gear band and said low profile fixed spline; and
a flexible-band-compensating rigid torque transmitter to transfer said relative torque motion from said deformable gear band to said output wheel, said flexible-band-compensating rigid torque transmitter comprising:
a plurality of spline flanges attached to said deformable gear band; and
a plurality of force transmitting joints attached to said output wheel and to said plurality of spline flanges, to accommodate a deformation of said deformable gear band.

2. The gearbox of claim 1 wherein said force transmitting joints are one of: a conjugating force transmitting joint and a planar force transmitting joint.

3. The gearbox of claim 2 wherein said conjugating force transmitting joint comprises an output flange and a force transmitting pin conjugating within said output flange, said output flange having one of a 4-point conjugating slot profile and a 2-point conjugating slot profile.

4. The gearbox of claim 2 wherein said planar force transmitting joint comprises a planar interface and a force transmitting pin engaging said planar interface.

5. The gearbox of claim 4 wherein said planar interface has a cylindrical torsional spring profile.

6. The gearbox of claim 4 wherein said planar interface has a conical torsional spring profile and at least a portion of said force transmitting pin is conical.

7. The gearbox of claim 4 wherein said planar interface is integrally formed with said force transmitting pin.

8. The gearbox of claim 1 wherein said plurality of force transmitting joints are attached to said output wheel with one of a fixed pitch, a variable pitch, and a free-rotating pitch.

9. The gearbox of claim 1 wherein at least one of said plurality of spline flanges is attached to at least one of: at least one tooth of said deformable gear band, an inner face of said deformable gear band, an inner lateral face of said deformable gear band, and an outer lateral face of said deformable gear band.

10. A wave transmission slewing drive, the drive comprising:
an output wheel;
a deformable gear band having external teeth, to transmit relative torque motion to said output wheel, said deformable gear band being as wide as its external teeth;
a low profile fixed spline having internal teeth, to mesh with said external teeth of said deformable gear band, having a width which is a function of said width of said deformable gear band;
a wave generator to deform said deformable gear band within said low profile fixed spline to generate said relative torque motion between said deformable gear band and said low profile fixed spline;
a flexible-band-compensating rigid torque transmitter to transfer said relative torque motion from said deformable gear band to said output wheel; and
a toroidal motor to provide motive force to said wave generator,
wherein said flexible-band-compensating rigid torque transmitter comprises:
a plurality of spline flanges attached to said deformable gear band; and
a plurality of force transmitting joints attached to said output wheel and to said plurality of spline flanges, to accommodate a deformation of said deformable gear band.

11. The drive of claim 10 wherein said force transmitting joints are one of a conjugating force transmitting joint and a planar force transmitting joint.

12. The drive of claim 11 wherein said conjugating force transmitting joint comprises an output flange and a cylindrical force transmitting pin conjugating within said output flange, said output flange having one of a 4-point conjugating slot profile and a 2-point conjugating slot profile.

13. The drive of claim 11 wherein said planar force transmitting joint comprises a planar interface and a force transmitting pin engaging said planar interface.

14. The drive of claim 13 wherein said planar interface has a cylindrical torsional spring profile.

15. The drive of claim 13 wherein said planar interface has a conical torsional spring profile and at least a portion of said force transmitting pin is conical.

16. The drive of claim 13 wherein said planar interface is integrally formed with said force transmitting pin.

17. The drive of claim 10 wherein said plurality of force transmitting joints are attached to said output wheel with one of a fixed pitch, a variable pitch, and a free-rotating pitch.

18. The drive of claim 10 wherein at least one of said plurality of spline flanges is attached to at least one of: at least one tooth of said deformable gear band, an inner face of said deformable gear band, an inner lateral face of said deformable gear band, and an outer lateral face of said deformable gear band.

19. The drive of claim 10 wherein said toroidal motor is a brushless toroidal motor.

20. The drive of claim 10 wherein said output wheel has a central cavity, said deformable gear band has a central cavity, said low profile fixed spline has a central cavity, said wave generator has a central cavity, and said toroidal motor has a central cavity, and wherein said central cavities together form a through-hole to provide passage for at least one of: electric cables, pneumatic cables, and fiber optic cables.
